(19) United States
(12) Patent Application Publication
(10) Pub. No.: US 2019/0078695 A1
(43) Pub. Date: Mar. 14, 2019

(54) VALVE ASSEMBLY

(71) Applicant: EFFEBI S.p.A., Bovezzo (IT)

(72) Inventor: Ermanno TANGHETTI, Concesio (IT)

(21) Appl. No.: 15/698,875

(22) Filed: Sep. 8, 2017

(51) Int. Cl. F16K 15/18; F16K 5/06; F16K 15/02

(52) U.S. Cl. CPC F16K 15/188; F16L 15/00; F16K 15/021; F16K 5/0605

(57) ABSTRACT

A valve assembly is provided with a first valve body provided with a first chamber; a shutter, which is movable in the first chamber and is connected to a control device; a second valve body, coupled to the first valve body and provided with a second chamber communicating with the first chamber; a check valve, at least partially housed in the second chamber; at least a first fitting, mechanically coupled to the second valve body; the second valve body and the first fitting being distinct pieces.

### CROSS-REFERENCE TO RELATED APPLICATIONS

This application is related to Italian Utility Model Application No. 202016000026041 filed on Mar. 11, 2016, the disclosure of which is incorporated by reference.

### TECHNICAL FIELD

The present invention relates to a valve assembly. For example, the valve assembly according to the present invention may be used in hydraulic circuits for heating or for connecting a water supply to a home network, or in all those applications requiring the interruption of a fluid flow in a circuit.

### BACKGROUND OF THE INVENTION

Some known valve assemblies comprise a ball valve and a check valve arranged in series. The ball valve intercepts the fluid flow by means of an ON/OFF system, whereas the check valve prevents any backflow toward the ball valve.

The check valve prevents any fluid backflow phenomena that may contaminate the inlet flow or damage the operation of the ball valve or of other components of the hydraulic circuit comprising the valve assembly.

However, the structure of this kind of valve assemblies makes storage very expensive. Moreover, the structure of this kind of valve assemblies imposes limitations with regard to the flow rate of the valve assemblies.

### SUMMARY OF THE INVENTION

It is therefore an object of the present invention to provide a valve assembly which is free from the aforesaid prior art drawbacks; in particular, it is an object of the present invention to provide a valve assembly for hydraulic use overcoming the aforementioned drawbacks in a simple and inexpensive way, both from the functional point of view and from the structural point of view.

According to these objects, the present invention relates to a valve assembly for hydraulic use comprising:
a first valve body, which is provided with a first chamber;
a shutter, which is movable in the first chamber and is connected to a control device;
a second valve body, coupled to the first valve body and provided with a second chamber communicating with the first chamber;
a check valve, at least partially housed in the second chamber;
at least a first fitting, mechanically coupled to the second valve body; the second valve body and the first fitting being distinct pieces.

If the second valve body and the first fitting are distinct pieces, there are obvious advantages in terms of storage cost savings. Thanks to the claimed solution, stocks of fittings having different diameter or different coupling and compatible with commercially available pipes, and stocks of universal blocks comprising the first valve body and the second valve body, which can be coupled to the fittings having different size and different coupling are stored. In this way, the stocks of universal blocks (more expensive) are easily disposed of, while the stocks of fittings having different size or different coupling (less expensive) are stored.

Moreover, thanks to the fact that the second valve body and the first fitting are distinct pieces, the second valve body can also be sized to house check valves having a diameter larger than the one of the inner passageway of the first fitting. In known solutions, in fact, the check valves may have, at most, the diameter of the passageway defined by the first fitting. Thanks to the solution according to the present invention, the second chamber may be sized to accommodate check valves having a diameter larger than the diameter of the passageway of the first fitting. Thanks to this, the second chamber may be sized to house a check valve that minimizes load losses.

According to a preferred embodiment of the present invention, the first valve body and the second valve body are made in one piece. In this way, the structure of the block comprising the first valve body and the second valve body is more stable and less prone to breakage.

According to a preferred embodiment of the present invention, the first fitting is coupled to the second valve body by means of a snap-fit. In this way, the coupling between the first fitting and the second valve body is quick and easy.

According to a preferred embodiment of the present invention, the first fitting is coupled to the second valve body by means of a coupling allowing the free rotation between the second valve body and the first fitting and preventing any uncoupling between the second valve body and the first fitting. In this way, coupling the valve assembly to a pipe, e.g. when mounting the valve assembly in a hydraulic circuit, just requires a rotation of the first fitting without necessarily rotating the entire assembly comprising at least the first valve body and the second valve body.

According to a preferred embodiment of the present invention, the second chamber is defined by a wall having a substantially cylindrical inner cross section. In this way, the second chamber can house most of the pre-assembled and commercially available check valves.

According to a preferred embodiment of the present invention, the first fitting is shaped so as to define a substantially cylindrical passageway communicating with the second chamber; the diameter of the passageway being equal to or smaller than the diameter of the second chamber. In this way, the size of the section of the second chamber may be selected independently from the size of the passageway of the first fitting. The cross section of the passageway of the first fitting, in fact, can be greatly limited by the size of the pipes to which the valve assembly is coupled.

According to a preferred embodiment of the present invention, the first valve body comprises an inlet connector and an outlet connector communicating with the first chamber; the outlet connector is coupled to the second valve body and defines an abutment ring for a check valve swing. This avoids the reduction of the diameter of the passageway in the second chamber due to the presence of the abutment ring. Moreover, this kind of structure is simplified and results in a saving because of the reduction of the components of the valve assembly.

According to a preferred embodiment of the present invention, the first valve body is mechanically coupled to a second fitting; the first valve body and the second fitting being distinct pieces. Analogously to what stated with regard to the second valve body and to the first fitting, the fact that the first valve body and the second fitting are distinct pieces has obvious advantages in terms of storage cost savings. Thanks to the claimed solution, stocks of first fittings and second fittings, having different diameter or different coupling and compatible with commercially available pipes, and stocks of universal blocks, comprising the first valve body and the second valve body, which can be coupled to fittings having different size or different coupling, are stored. In this way, the stocks of universal blocks (more expensive) are easily disposed of, while the stocks of first fittings and second fittings having different size and coupling (less expensive) are stored.

### BRIEF DESCRIPTION OF THE DRAWINGS

Further characteristics and advantages of the present invention will become apparent from the following description of a non-limiting example of embodiment with reference to the figures of the accompanying drawings, wherein:

FIG. 1 is a schematic view with parts in section and parts removed for clarity's sake of a valve assembly according to the present invention.

FIG. 2 is a schematic view with parts in section and parts removed for clarity's sake of a detail of the valve assembly in accordance with a variant of the present invention.

### DETAILED DESCRIPTION OF THE INVENTION

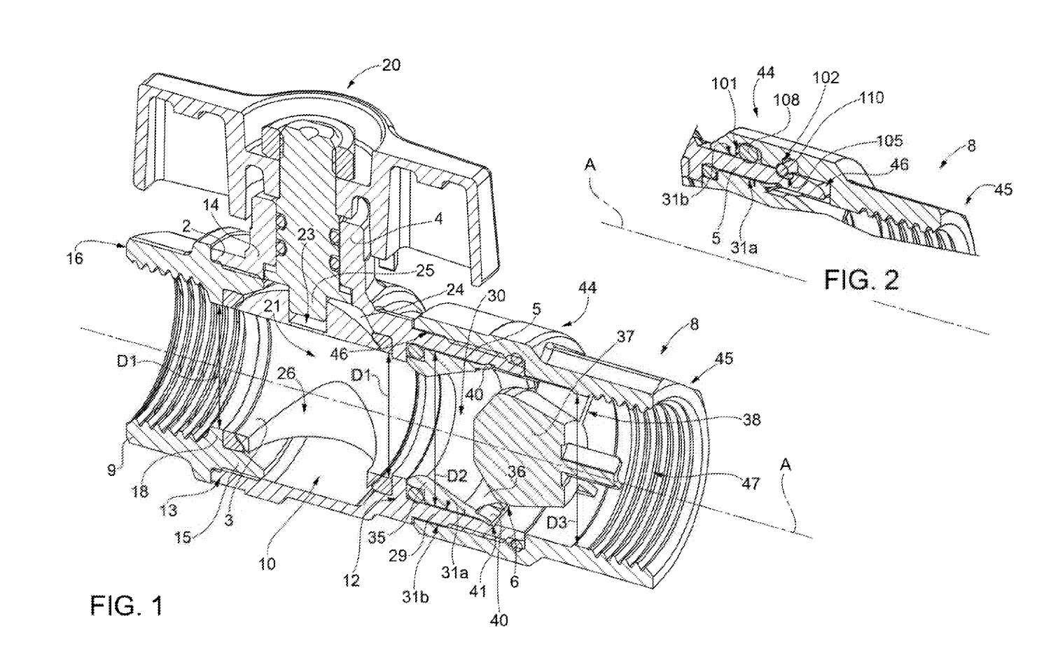

FIG. 1 indicates with the reference number 1 a valve assembly according to the present invention comprising a first valve body 2, a shutter 3 housed in the first valve body 2, a control cylinder 4, a second valve body 5 coupled to the first valve body 2, a check valve 6 at least partially housed in the second valve body 5, a first fitting 8 coupled to the second valve body 5 and a second fitting 9 coupled to the first valve body 2.

The first valve body 2 comprises a chamber 10 for housing the shutter 3, an outlet connector 12 communicating with the chamber 10 and coupled to the second valve body 5, an inlet connector 13 communicating with the chamber 10 and coupled to the second fitting 9, and an auxiliary connector communicating with the chamber 10 and coupled to the control cylinder 4.

Preferably, the outlet connector 12 and the inlet connector 13 are aligned along an axis A, while the auxiliary connector 14 is substantially orthogonal to the outlet connector 12 and to the inlet connector 13. Preferably, the outlet connector 12, the inlet connector 13 and the auxiliary connector 14 have a circular cross section.

A variant not shown provides that the outlet connector 12 and the inlet connector 13 are orthogonal to each other. Therefore, the chamber 10 is provided with three openings, which are respectively defined by the outlet connector 12, by the inlet connector 13 and by the auxiliary connector 14.

The inlet connector 13 is coupled to the second fitting 9, preferably by means of a threaded coupling system. A variant provides that the coupling between the inlet connector 13 and the second fitting 9 is of the quick type, e.g. a snap-fit.

In the non-limiting example here described and shown, the second fitting 9 is provided with a first end portion 15 coupled to the inlet connector 13 of the first valve body 2, a second end portion 16, which can be coupled to outer hydraulic elements (not shown for simplicity's sake in the enclosed figures) and an intermediate ring 18, which protrudes internally to define a containment element for the shutter 3 in the chamber 10.

In the non-limiting example here described and shown, the first end portion 15 is shaped to define an externally threaded female element, configured to be screwed to the respective internally threaded inlet connector 13.

In the non-limiting example here described and shown, the second end portion 16 is internally threaded. The second end portion 16 can be manufactured with different coupling systems to be compatible with commercially available hydraulic components.

In the non-limiting example here described and shown, the diameter D1 of the outlet connector 12 is substantially identical to the diameter of the intermediate ring 18 of the second fitting 9.

Preferably, the chamber 10 has a substantially cylindrical or frustoconical shape.

In the non-limiting example here described and shown, the valve body 2 and the control cylinder 4 are made in one piece.

The shutter 3 is coupled to a control device 20 housed in the control cylinder 4, and is movable between an open position (shown in FIG. 1), allowing the passage of a fluid flow through the first valve body 2, and a closed position (not shown in the enclosed figures), preventing the passage of a fluid flow through the first valve body 2. In particular, the shutter 3 has a spherical shape and comprises an inner through channel 21 and a groove 23 formed on the outer surface 24 and adapted to be engaged by a portion 25 of the control device 20 so that a rotation of the control device 20 determines a corresponding rotation of the shutter 3.

Preferably, the portion 25 of the control device 20 engages the groove 23 with a certain clearance, so that in the closed position the shutter 3 oscillates around an axis perpendicular to the axis A. The oscillating movement of the shutter 3 optimizes the sealing of the valve assembly 1 when the shutter 3 is in the closed position.

In the open position, the shutter 3 is arranged so that the inner channel 21 is substantially aligned along the axis A to allow the passage of a fluid (configuration of FIG. 1), while in the closed position the shutter 3 is arranged so that the outer surface 24 occludes the inlet connector 13 to prevent the passage of a fluid through the valve body 2.

Preferably, the shutter 3 is provided with an opening 26 formed in a bottom portion of the shutter 3, substantially radially opposite to the position of the groove 23. This opening 26 prevents the stagnation of the water around the shutter 3 when the shutter 3 is in the closed position. This avoids any stagnation that could promote a bacterial growth (e.g. legionella).

The second valve body 5 comprises a hollow wall 29 defining a second chamber 30. The wall 29 is shaped so as to have, at the chamber 30, a circular inner cross section and a circular outer cross section. The wall 29 is provided with an inner surface 31a having a substantially cylindrical shape and with an outer surface 31b, which is also substantially cylindrical.

The second valve body 5 is coupled to the first valve body 2, and preferably to the outlet connector 12 of the first valve body 2.

In the non-limiting example here described and shown, the first valve body 2 and the second valve body 5 are made in one piece.

The second chamber 30 has a diameter D2 preferably larger than the diameter D1.

The second valve body 5 is coupled to the first fitting 8. Preferably, the second valve body 5 is threaded along the outer surface 31b of the wall 29 to be coupled to a respective inner thread of the fitting 8, as explained in more detail later.

The chamber 30 houses, at least partially, the check valve 6.

The check valve 6 allows the flow in one direction and prevents it in the opposite direction.

In particular, the check valve 6 is configured to allow the flow from the first chamber 10 to the second chamber 30 and to prevent the backflow of the fluid from the second chamber 30 to the first chamber 10.

In the non-limiting example here described and shown, the check valve 6 comprises an abutment ring 35, a support ring 36, a swing 37 movable between an open position and a closed position, and a leading structure 38 coupled to the support ring 36 and configured to lead, in use, the movement of the swing 37 between the open position (shown in FIG. 1) and the closed position.

The abutment ring 35 is coupled to the support ring 36 and causes a narrowing of the diameter D2 of the chamber 30. In the non-limiting example here described and shown, the abutment ring 35 has a diameter smaller than the diameter D1 of the outlet connector 12.

In particular, the abutment ring 35 defines an abutment edge along which the swing 37 rests in the closed position. A variant not shown provides that the connector 12 defines the abutment ring for the swing 37.

A further variant provides that the abutment ring 35 is made in one piece with the second valve body 5, and in particular with the wall 29. In other words, the second valve body 2 is shaped so as to define an abutment ring for a swing 37 of the check valve 6.

This prevents the reduction of the diameter of the passageway for the fluid flow due to the abutment ring 35. The support ring 36 is preferably fixed to the wall 29 of the second valve body 5 by means of a snap-fit. In the non-limiting example here described and shown, the snap-fit comprises flaps 40 engaging a respective groove 41 formed on the inner surface 31a of the wall 29.

A variant not shown provides that the support ring 36 is axially locked by a locking ring, for example of the first fitting 8, as described in detail later.

The leading structure 38 comprises a sort of cage coupled to the support ring 36 and configured to lock the swing 37 when the valve 6 is in the open position and to lead the swing 37 passing from the open position to the closed position and vice versa.

The first fitting 8 is provided with a first portion 44 coupled to the outlet connector 12 of the first valve body 2 and with a second portion 45, which can be coupled to outer hydraulic elements (not shown for simplicity's sake in the enclosed figures).

In the non-limiting example here described and shown, the first portion 44 is shaped to define an internally threaded male element and is configured to be screwed to the thread on the outer surface 31b of the second valve body 5. In the non-limiting example here described and shown, the second portion 45 is internally threaded. The second portion 45 can be manufactured with different coupling systems to be compatible with commercially available hydraulic components.

Preferably, the first portion 44 and the second portion 45 are shaped to define internally respective inner ducts having a substantially cylindrical shape.

In particular, the first portion 44 is configured to define a first inner duct 46 having a diameter larger than the outer diameter of the second valve body 5.

The second portion 45 is configured to define a second inner duct 47 having a diameter D3.

When the first connector 8 is coupled to the second valve body 5, the inner duct 47 communicates with the second chamber 30.

The diameter D3 of the second portion 45 is determined by the section of the hydraulic element to which the valve assembly 1 will be coupled.

In the non-limiting example here described and shown, the diameter D3 is equal to the diameter D2 of the second chamber 30.

A variant provides that the diameter D3 of the second inner duct of the fitting 8 is smaller than the diameter of the second chamber 30. In this way, the chamber 30 can be sized so as to minimize the load losses regardless of the cross sections of the hydraulic elements to which the valve assembly 1 must be coupled.

FIG. 2 shows a variant of the coupling mechanism between the first connector 8 and the second valve body 5. In this configuration, the first connector 8 is coupled to the second valve body 5 by means of a quick coupling mechanism, preferably a snap-fit.

In particular, the first connector 8 is provided with a first annular groove 101 and with a second annular groove 102 formed along the inner cylindrical surface of the first duct 46.

The second valve body 5 is provided with an annular groove 105 formed along the outer surface 31b so as to face the second annular groove 102 of the first connector 8 when the first connector 8 and the second valve body 5 are coupled. The first groove 101 houses a sealing ring 108. The second groove 102 and the annular groove 105 house an elastic ring 110, preferably of the Seeger type. This type of quick coupling is irreversible. Once coupled, the second connector 8 and the second valve body 2 cannot be uncoupled.

The relative position between the first annular groove 101 and the second annular groove 102 is irrelevant for the performance of the quick coupling.

In the non-limiting example here described and shown, the first annular groove 101 is close to the end portion of the second valve body 5 facing, in use, the first valve body 2, and the second annular groove 102 is close to the end portion of the second valve body 5 facing, in use, the first connector 8. However, the position of the first annular groove 101 and of the second annular groove 102 may be reversed.

This type of coupling allows the rotation between the first connector 8 and the second valve body 5. In this way, coupling the valve assembly 1 to the outer hydraulic elements just requires the rotation of the connector 8 without rotating the assembly comprising at least the first valve body 2 and the second valve body 5.

Finally, it is clear that the valve assembly here described can be subject to modifications and variations without departing from the scope of the appended claims.

1. A valve assembly comprising:
a first valve body provided with a first chamber;
a shutter, which is movable in the first chamber and is connected to a control device;
a second valve body, coupled to the first valve body and provided with a second chamber communicating with the first chamber;
a check valve, at least partially housed in the second chamber; and
at least a first fitting, mechanically coupled to the second valve body, the second valve body and the first fitting being distinct pieces,
wherein the first fitting is coupled to the second valve body by means of a coupling allowing the free rotation between the second valve body and the first fitting and preventing the uncoupling between the second valve body and the first fitting.

2. The valve assembly according to claim 1, wherein the first valve body and the second valve body are made in one piece.

3. The valve assembly according to claim 8, wherein the first fitting is coupled to the second valve body by means of a threaded coupling.

4. The valve assembly according to claim 9, wherein the first fitting is coupled to the second valve body by means of a quick coupling.

5. (canceled)

6. The valve assembly according to claim 1, wherein the first fitting is coupled to the second valve body by means of an elastic ring.

7. The valve assembly according to claim 1, wherein the second chamber is defined by a wall having a substantially cylindrical inner cross section.

8. A valve assembly comprising:
a first valve body provided with a first chamber;
a shutter, which is movable in the first chamber and is connected to a control device;
a second valve body, coupled to the first valve body and provided with a second chamber communicating with the first chamber;
a check valve, at least partially housed in the second chamber; and
at least a first fitting, mechanically coupled to the second valve body, the second valve body and the first fitting being distinct pieces,
wherein the first fitting is shaped so as to define a substantially cylindrical passageway communicating with the second chamber; a diameter of the passageway being equal to or smaller than a diameter of the second chamber.

9. A valve assembly comprising:
a first valve body provided with a first chamber;
a shutter, which is movable in the first chamber and is connected to a control device;
a second valve body, coupled to the first valve body and provided with a second chamber communicating with the first chamber;
a check valve, at least partially housed in the second chamber; and
at least a first fitting, mechanically coupled to the second valve body, the second valve body and the first fitting being distinct pieces,
wherein the first fitting is shaped so as to define a substantially cylindrical passageway communicating with the second chamber; a diameter of the passageway being smaller than a diameter of the second chamber.

10. The valve assembly according to claim 1, wherein the check valve is a swing valve.

11. A valve assembly comprising:
a first valve body provided with a first chamber;
a shutter, which is movable in the first chamber and is connected to a control device;
a second valve body, coupled to the first valve body and provided with a second chamber communicating with the first chamber;
a check valve, at least partially housed in the second chamber; and
at least a first fitting, mechanically coupled to the second valve body, the second valve body and the first fitting being distinct pieces,
wherein the first fitting is shaped so as to define a substantially cylindrical passageway communicating with the second chamber; a diameter of the passageway being smaller than a diameter of the second chamber,
wherein the first valve body comprises an inlet connector and an outlet connector communicating with the first chamber; the outlet connector being coupled to the second valve body.

12. The valve assembly according to claim 11, wherein the inlet connector and the outlet connector are aligned along a longitudinal axis (A).

13. (canceled)

14. The valve assembly according to claim 11, wherein the outlet connector defines an abutment ring for a swing of the check valve.

15. The valve assembly according to claim 10, wherein the second valve body is shaped so as to define an abutment ring for a swing of the check valve.

16. (canceled)

17. A valve assembly comprising:
a first valve body provided with a first chamber;
a shutter, which is movable in the first chamber and is connected to a control device;
a second valve body, coupled to the first valve body and provided with a second chamber communicating with the first chamber;
a check valve, at least partially housed in the second chamber; and
at least a first fitting, mechanically coupled to the second valve body, the second valve body and the first fitting being distinct pieces,
wherein the first valve body is mechanically coupled to a second fitting; the first valve body and the second fitting being distinct pieces,
wherein the first valve body comprises an inlet connector and an outlet connector communicating with the first chamber; the inlet connector being coupled to the second fitting.
